(19) United States
(12) Patent Application Publication
(10) Pub. No.: US 2017/0122023 A1
(43) Pub. Date: May 4, 2017

(54) WINDOW REGULATOR

(71) Applicant: Johnan Manufacturing Inc., Nagano (JP)

(72) Inventor: Koudai YOSHIHARA, Nagano (JP)

(73) Assignee: Johnan Manufacturing Inc., Nagano (JP)

(21) Appl. No.: 15/318,572

(22) PCT Filed: Dec. 3, 2015
(86) PCT No.: PCT/JP2015/083969

§ 371 Date: Dec. 13, 2016

(30) Foreign Application Priority Data
Dec. 5, 2014 (JP) 2014-246617

(51) Int. Cl. E05F 15/689

(52) U.S. Cl. CPC E05F 15/689

(57) ABSTRACT

A window regulator for opening and closing a window glass arranged at a door of a vehicle includes an arm member that is rotated by a driving unit so as to lift and lower the window glass. The arm member includes an inside extending portion that extends in form of a staircase via first and second inside bending sections that form folds including a mountain fold and a valley fold in a longitudinal direction, and an outside bead portion that is bent and projected outwardly from an outer peripheral end of the inside extending portion and that is bent in form of a staircase via first and second outside bending sections that form folds including a mountain fold and a valley fold in the longitudinal direction. The first and second inside bending sections are formed between the first outside bending section and the second outside bending section.

### TECHNICAL FIELD

The invention relates to a window regulator which opens and closes a window glass arranged at a door for vehicle.

### BACKGROUND ART

A window regulator which opens and closes a window glass by driving force of a driving motor is used frequently for a door for vehicle. This kind of window regulator includes an X-arm type window regulator which combines a lift arm and an equalizer arm such that they can rotate relatively at a rotational axis (see e.g., PTL1).

In the window regulator described in PTL1, a tip end (one end) of a main arm (lift arm) is connected slidably with a lift arm bracket which is attached to a lower end of the window glass via a roller, and a base end (other end) of the main arm is connected with an actuator. On the other hand, one end of a sub-arm (equalizer arm) is connected slidably with the lift arm bracket of the window glass via a roller and the other end of the sub-arm is connected slidably with an equalizer arm bracket which is attached to an inner panel of a door main body via a roller.

A vertical bead which extends from the tip end to the base end in a longitudinal direction is formed on a general surface of the main arm. The main arm has a bending section which forms folds having a mountain fold and a valley fold at same position in the longitudinal direction of the general surface and the vertical bead. It is set to be at different height positions in a vertical direction via the bending section.

### CITATION LIST

### Patent Literature

PTL1: JP-A-2012-117248

### SUMMARY OF INVENTION

### Technical Problem

The main arm described in PTL1 is configured to bend by the bending section at the same position the longitudinal direction of the general surface and the vertical bead. However, if stress above a certain level is applied to the main arm in lifting and lowering the window glass by the driving force of the driving motor, the general surface may deform as the bending section becomes an origin to bend the general surface. Thus, the main arm has a problem about the rigidity.

It is an object of the present invention to provide a window regulator that is improved in the rigidity of the main arm.

### Solution to Problem

According to an embodiment of the invention, a window regulator for opening and closing a window glass arranged at a door of a vehicle comprises an arm member that is rotated by a driving unit generating a drive force to lift and lower the window glass so as to lift and lower the window glass,

wherein the arm member comprises an inside extending portion that extends in form of a staircase via first and second inside bending sections that form folds comprising a mountain fold and a valley fold in a longitudinal direction, and an outside bead portion that is bent and projected outwardly from an outer peripheral end of the inside extending portion and that is bent in form of a staircase via first and second outside bending sections that form folds comprising a mountain fold and a valley fold in the longitudinal direction, and
wherein the first and second inside bending sections are formed between the first outside bending section and the second outside bending section.

### Advantageous Effects of Invention

According to an embodiment of the present invention, the window regulator can be provided that is improved in the rigidity of the arm member by dispersing the stress concentration caused in the bending section of the arm member.

### BRIEF DESCRIPTION OF DRAWINGS

FIG. 1 is a plan view showing schematically a window regulator in an embodiment according to the present invention.

FIG. 2 is a perspective view showing schematically a main arm which is one component of the window regulator in the embodiment.

FIG. 3A is a plan view showing the main arm in the embodiment.

FIG. 3B is a side view viewed from an arrow direction of a line A-A in FIG. 3A.

FIG. 3C is a cross sectional view cut along the line A-A in FIG. 3A and viewed from the arrow direction.

FIG. 4 is a perspective view showing schematically a main arm in a comparative example.

FIG. 5 is a plan view showing the main arm in the comparative example.

### DESCRIPTION OF EMBODIMENTS

Next, a preferred embodiment according to the invention will be described below with reference to the appended drawings.

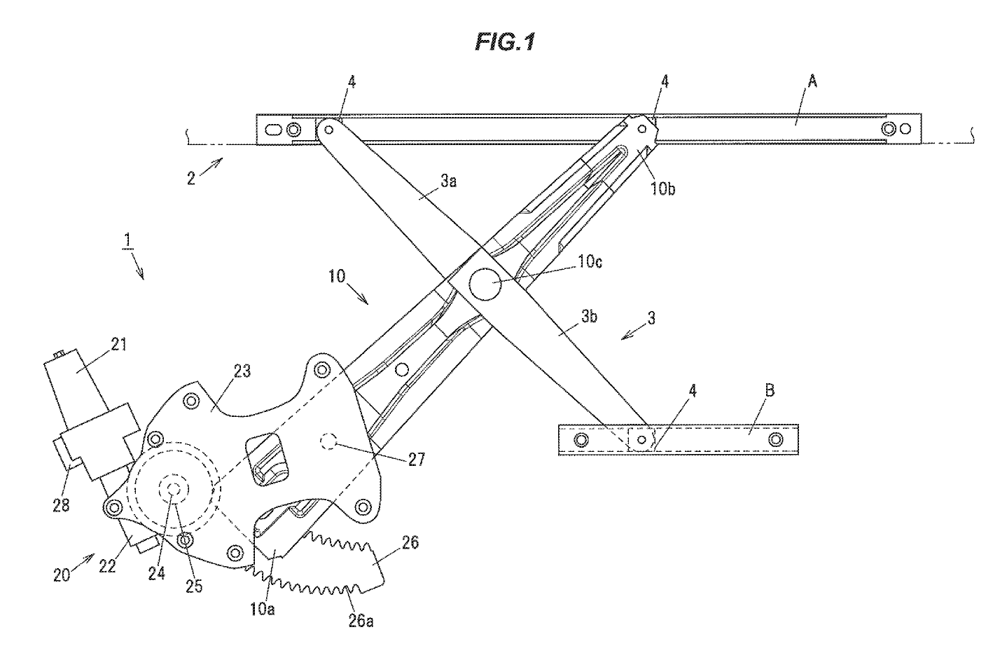

FIG. 1 is a plan view showing schematically a window regulator in the embodiment. Meanwhile, one example that the window regulator is viewed from a door inner panel side which configures a door inner plate is shown in FIG. 1.

### (Whole Structure of Window Regulator)

A window glass 2 is arranged in a door of a vehicle (not shown). The window glass 2 can move up and down along a door sash (not shown) which is arranged in the door. A window regulator 1 which lifts and lowers the window glass 2 is arranged between the door inner panel and a door outer panel.

The window regulator 1 is provided with a main arm 10, a sub-arm 3 which intersects with the main arm 10 in X-shaped configuration, and is combined with the main arm 10 such that can rotate relatively, and a driving unit 20 which generates driving power to lift and lower the window glass 2. The window regulator 1 is a power window regulator that the main arm 10 is rotated by the driving unit 20 to automatically lift and lower the window glass 2. Meanwhile, the main arm 10 is one embodiment of “arm member” according to the present invention.

The main arm 10 and the sub-arm 3 are made of a press molded long steel plate. The main arm 10 is connected to the sub-arm 3 at a joint 10c between a base end part 10a and a tip end part 10b. The sub-arm 3 can turn around the joint 10c. The main arm 10 is attached on a base plate 23 such that the main arm 10 rotates freely around a spindle 27.

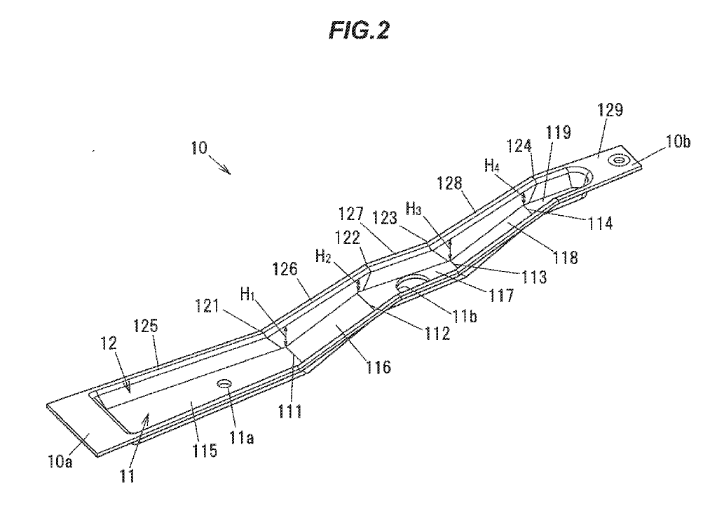

The sub-arm 3 is provided with a first sub-arm 3a and a second sub-arm 3b. The first sub-arm 3a is arranged at a lower side of the main arm 10 between the joint 10c and a channel A. The second sub-arm 3b is arranged at an upper side of the main arm 10 between the joint 10c and a channel B. Both joint 10c side ends of the first and second sub-arms 3a, 3b are connected via a joint circular hole 11b (cf. FIG. 2) which is formed on the main arm 10 by welding.

An arc-shaped sector gear 26 which is made of a steel plate is fixed at the base end part 10a of the main arm 10 by welding. A gear part 26a to engage with a pinion gear 25 is formed on an arc-shape outer peripheral surface of the sector gear 26. A slider 4 is fixed so as to rotate freely at the tip end part 10b of the main arm 10. The slider 4 is attached so as to move freely on the channel A which is fixed on a lower end of the window glass 2 along a longitudinal direction.

One end part of the first sub-arm 3a is connected to the channel A which is fixed on the lower end of the window glass 2 via the slider 4. One end part of the second sub-arm 3b is connected to the channel B which is fixed on the lower end of the window glass 2 via the slider 4. The slider 4 on the channel A side is attached so as to move freely along a longitudinal direction of the channel A. Also, the slider 4 on the channel B side is attached so as to move freely along a longitudinal direction of the channel B.

The driving unit 20 is provided with an electric motor 21 and a reducer 22. The reducer 22 is provided with a worm-gear structure and is received in a gear-case (not shown) which is fixed on the base plate 23.

The worm-gear structure is provided with a worm which is fixed on a rotational shaft of the electric motor 21, and a worm wheel to engage with the worm. A pinion gear 25 which is arranged on an outer surface of a gear cover is fixed on a tip end of a worm wheel output shaft 24.

A connector 28 which is connected electrically to a control unit (not shown) mounted on the vehicle is arranged at the gear case. The electric motor 21 is controlled by a command signal from a power window switch (not shown) etc.

The sector gear 26 drives and rotates with the main arm 10 in the range of a predetermined angle about the spindle 27 via the pinion gear 25 which rotates at a reduced speed by the reducer 22 when the electric motor 21 is driven and rotated. The rotational power of the sector gear 26 is transmitted to the main arm 10, and the main arm 10 swings toward the window glass 2 about the spindle 27. Along with the rotational movement of the main arm 10, the sub-arm 3 swings toward the window glass 2 and the door about the joint 10c to open and close the window glass 2 in the vertical directions of the vehicle.

### (Whole Structure of Main Arm)

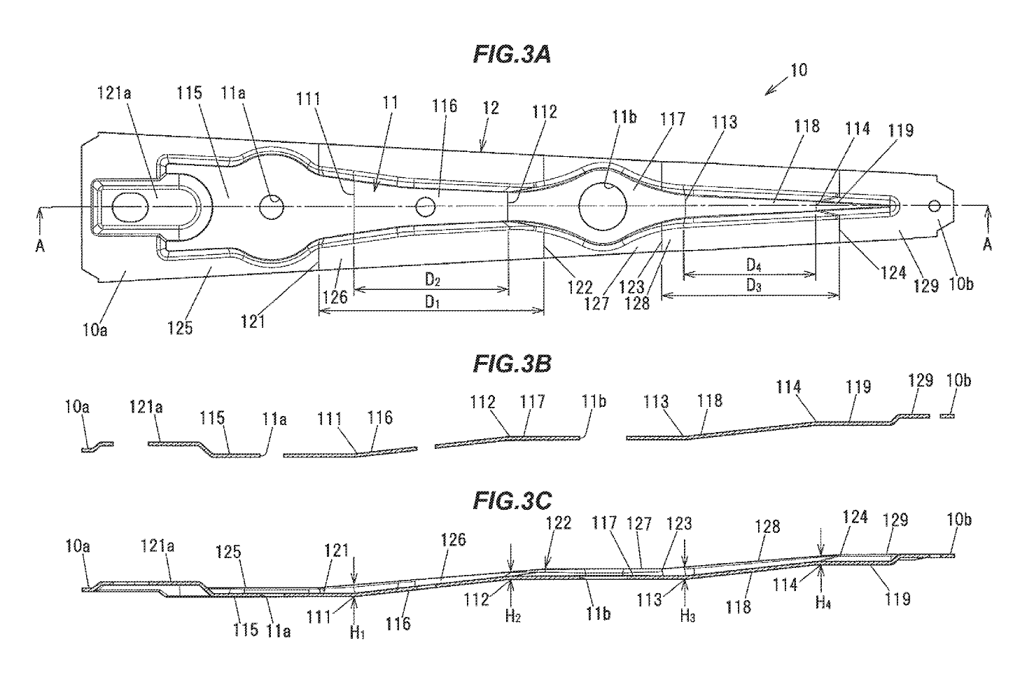

FIG. 2 is a perspective view showing schematically the main arm 10. FIG. 3A is a plan view showing the main arm. FIG. 3B is a side view viewed from an arrow direction of a line A-A in FIG. 3A. FIG. 3C is a cross sectional view cut along the line A-A in FIG. 3A and viewed from the arrow direction. Meanwhile, FIG. 2 shows exaggeratingly the difference of positions of respective parts in the main arm 10 in a vehicle width direction for clarification.

The main arm 10 is provided with an inside extending portion 11 which is formed by extending the long steel plate in the longitudinal direction at a center of the long steel plate in the width direction, and an outside bead portion 12 which is bent and projected outwardly from an outer peripheral end of the inside extending portion 11. The outside beading portion 12 is formed at both width direction ends which sandwiches the inside extending portion 11 in the lateral direction of the long steel plate. Whole of the main arm 10 is formed into such a shape that the width dimension is reduced gradually from the base end part 10a to the tip end part 10b in the longitudinal direction of the long steel plate, and is configured to be bent in the form of a staircase toward a door outer panel side which configures an outside plate of the door.

The inside extending portion 11 of the main arm 10 is provided with first to fourth inside bending sections 111 to 114 that form folds including a mountain fold and a valley fold in the longitudinal direction of the long steel plate, and is configured to integrally have first to fifth inside plane portions 115 to 119 which are bent in the form of a staircase via the first to fourth inside bending sections 111 to 114. Viewing from a side shown in FIG. 3A, the first and third inside bending sections 111, 113 are valley folds, and the second and fourth inside bending sections 112, 114 are mountain folds.

The first, third, and fifth inside plane portions 115, 117, 119 among the first to fifth inside plane portions 115 to 119 are formed as uneven parallel planes which are at different positions in the vehicle width direction. The second inside plane portion 116 between the first inside plane portion 115 and the third inside plane portion 117, and the fourth inside plane portion 118 between the third inside plane portion 117 and the fifth inside plane portion 119 are formed as slant planes which are inclined from the first, third, fifth inside plane portions 115, 117, 119.

Accordingly, the inside extending portion 11 of the main arm 10 is configured so as to have the parallel plane of the first inside plane portion 115, the slant plane of the second inside plane portion 116, the parallel plane of the third inside plane portion 117, the slant plane of the fourth inside plane portion 118, and the parallel plane of the fifth inside plane portion 119 which are integrally continuously formed in the form of a staircase from the base end part 10a to the tip end part 10b.

For convenience, the following explanations will be made such that the uneven direction (vehicle width direction) of the first, third, fifth inside plane portions 115, 117, 119 in the main arm 10 is defined as a height direction to which the parallel plane of the first inside plane portion 115 is referenced.

A supporting circular hole 11a is formed penetrating through the first inside plane portion 115 at a position corresponding to the spindle 27 of the base plate 23. A jointing circular hole 11b is formed penetrating through the third inside plane portion 117 at a position corresponding to the joint 10c. The jointing circular hole 11b is formed so as to have a larger diameter than the supporting circular hole 11a, and the jointing circular hole 11b is at a higher position than the supporting circular hole 11a.

On the other hand, the outside bead portion 12 of the main arm 10 is provided with first to fourth outside bending sections 121 to 124 that form folds including a mountain fold and a valley fold in the longitudinal direction of the long steel plate, and is configured to integrally have first to fifth outside plane portions 125 to 129 which are bent in the form of a staircase via the first to fourth outside bending sections 121 to 124. Viewed from the side shown in FIG. 3A, the first and third outside bending sections 121, 123 are valley folds and the second and fourth outside bending section 122, 124 are mountain folds.

The first, third, and fifth outside plane portions 125, 127, 129 among the first to fifth outside plane portions 125 to 129 are formed as uneven parallel planes. The second outside plane portion 126 between the first outside plane portion 125 and the third outside plane portion 127, and the fourth outside plane portion 128 between the third outside plane portion 127 and the fifth outside plane portion 129 are formed as slant planes which are inclined from the first, third, fifth outside plane portions 125, 127, 129.

Accordingly, the outside bead portion 12 of the main arm 10 is configured so as to have the parallel plane of the first outside plane portion 125, the slant plane of the second outside plane portion 126, the parallel plane of the third outside plane portion 127, the slant plane of the fourth outside plane portion 128, and the parallel plane of the fifth outside plane portion 129 which are integrally continuously formed in the form of a staircase from the base end part 10a to the tip end part 10b.

As shown in FIGS. 3A to 3C, a projecting bead section 121a which projects in the height direction is formed at an end part of the first outside plane portion 125 in the longitudinal direction. Also, an opposite surface (uneven surface with reference to the first inside plane portion 115) of the first outside plane portions 125 which sandwiches the first inside plane portion 115 in the width direction of the main arm 10 is formed into a curved shape which expands outwardly at a position corresponding to a circular opening of the supporting circular hole 11a. Also, an opposite surface (uneven surface with reference to the third inside plane portion 117) of the third outside plane portions 127 which sandwiches the third inside plane portion 117 in the width direction of the main arm 10 is formed into a curved shape which expands outwardly at a position corresponding to a circular opening of the jointing circular hole 11b.

### (Stress Dispersion and Rigidity Improvement Structure of the Main Arm)

The main arm 10 has a stress dispersion and rigidity improvement structure, in which the arrangement positions of one pair of adjacent outside bending section and adjacent inside bending section among the outside bending sections 121 to 124 and the inside bending sections 111 to 114 are reversed alternately toward the base end part 10a side of the main arm 10 and the tip end part 10b side of the main arm 10.

The first and second outside bending sections 121, 122 are formed between the supporting circular hole 11a and the jointing circular hole 11b in the longitudinal direction of the main arm 10. The first and second inside bending sections 111, 112 are formed between the first outside bending section 121 and the second outside bending section 122 in the longitudinal direction of the main arm 10. A distance D1 between the first outside bending section 121 and the second outside bending section 122 is set to be larger than a distance D2 between the first inside bending section 111 and the second inside bending section 112.

Thus, the arrangement position of one pair of the adjacent first outside and inside bending sections 121, 111 and the arrangement position of one pair of the adjacent second outside and inside bending sections 122, 112 are defined so as to be reversed alternately toward the base end part 10a side and the tip end part 10b side of the main arm 10. Thereby, the inclination of the second outside plane portion 126 is different from the inclination of the second inside plane portion 116 with respect to the height direction so as to have the first stress dispersion structure of the main arm 10.

By adopting the above first stress dispersion structure, a height H1 of the second outside plane portion 126 from the first inside bending section 111 is made to be more than a height H2 of the second outside plane portion 126 from the second inside bending section 112 (H1>H2). That is, the height of the second outside plane portion 126 from the second inside plane portion 116 is made to increase gradually from the second inside bending section 112 to the first inside bending section 111 side. Also, by forming the first and second inside bending sections 111, 112 between the first outside bending section 121 and the second outside bending section 122 in the longitudinal direction of the main arm 10, the difference between the heights H1 and H2 can be increased comparing with the case that the above arrangement relationship is reversed.

Thus, the rigidity of the main arm 10 in the longitudinal direction becomes strong as it gets closer to the supporting circular hole 11a which corresponds to the spindle 27 as the rotation center of the main arm 10 so as to make the first rigidity improvement structure of the main arm 10.

On the other hand, the third and fourth outside bending sections 123, 124 are formed between the supporting circular hole 11a and the jointing circular hole 11b in the longitudinal direction of the main arm 10. The third and fourth inside bending sections 113, 114 are formed between the third outside bending section 123 and the fourth outside bending section 124 in the longitudinal direction of the main arm 10. A distance D3 between the third outside bending section 123 and the fourth outside bending section 124 is set to be larger than a distance D4 between the third inside bending section 113 and the fourth inside bending section 114.

Thus, the arrangement position of one pair of the adjacent third outside and inside bending sections 123, 113, and the arrangement position of one pair of the adjacent fourth outside and inside bending sections 124, 114 are defined so as to be reversed alternately toward the base end part 10a side of the main arm 10 and the tip end part 10b side of the main arm 10. Thereby, the inclination of the fourth outside plane portion 128 in the height direction is different from the inclination of the fourth inside plane portion 118 with respect to the height direction so as to have the second stress dispersion structure of the main arm 10.

By adopting the above second stress dispersion structure, a height H3 of the fourth outside plane portion 128 from the third inside bending section 113 is made to be more than a height H4 of the fourth outside plane portion 128 from the fourth inside bending section 114 (H3>H4). That is, the height of the fourth outside plane portion 128 from the fourth inside plane portion 118 is made to increase gradually from the fourth inside bending section 114 to the third inside bending section 113 side. Also, by forming the third and fourth inside bending sections 113, 114 between the third outside bending section 123 and the fourth outside bending section 124 in the longitudinal direction of the main arm 10, the difference between the heights H3 and H4 can be increased comparing with the case that the above arrangement relationship is reversed.

Thus, the rigidity of the main arm 10 in the longitudinal direction becomes strong as it gets closer to the supporting circular hole 11a which corresponds to the spindle 27 as the rotation center of the main arm 10 so as to make the second rigidity improvement structure of the main arm 10.

The difference between the heights H1 and H2 is desirably 1 mm to 3 mm. Also, the difference between the heights H3 and H4 is desirably 1 mm to 3 mm. It is not especially limited thereto, for example, if the height H1 of the second outside plane portion 126 from the first inside bending section 111 is set to be 3 mm, it is preferable to set the height H2 of the second outside plane portion 126 from the second inside bending section 112 to be 1 mm, set the height H3 of the fourth outside plane portion 128 from the third inside bending section 113 to be 3 mm, and set the height H4 of the fourth outside plane portion 128 from the fourth inside bending section 114 to be 1 mm, respectively.

### Comparative Example

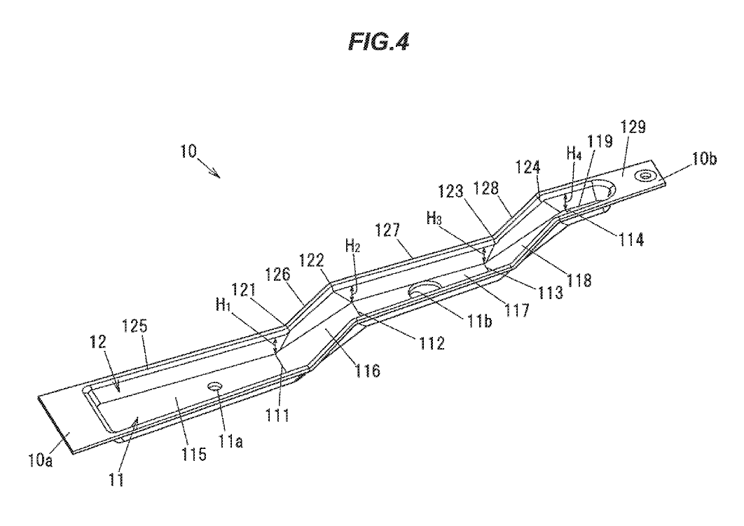

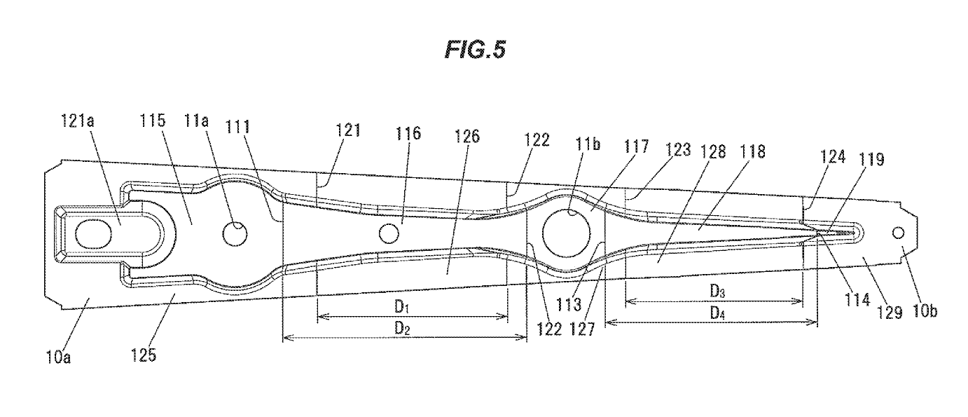

FIG. 4 is a perspective view showing schematically a main arm in a comparative example. FIG. 5 is a plan view showing the main arm in the comparative example.

The above embodiment is constructed such that the first and second inside bending sections 111, 112 are arranged between the first and second outside bending sections 121, 122, and the third and fourth inside bending sections 113, 114 are arranged between the third and fourth outside bending sections 123, 124. The comparative example is different from the above embodiment in that the outside bending sections 121 to 124 and the inside bending sections 111 to 114 are each disposed in the contrary arrangement to the above embodiment. Thus, the same reference numerals will be used below for the same elements in the above embodiment, wherein the detailed explanation thereof will be omitted.

The first and second outside bending sections 121, 122 are arranged between the first inside bending section 111 and the second inside bending section 112. Also, the third and fourth outside bending sections 123, 124 are arranged between the third inside bending section 113 and the fourth inside bending section 114.

The height H1 of the second outside plane portion 126 from the first inside bending section 111 is less than the height H2 of the second outside plane portion 126 from the second inside bending section 112 (H1<H2). That is, the height of the second outside plane portion 126 from the second inside plane portion 116 is made to decrease gradually from the second inside bending section 112 to the first inside bending section 111 side.

On the other hand, the height H3 of the fourth outside plane portion 128 from the third inside bending section 113 is less than the height H4 of the fourth outside plane portion 128 from the fourth inside bending section 114 (H3<H4). That is, the height of the fourth outside plane portion 128 from the fourth inside plane portion 118 is made to decrease gradually from the fourth inside bending section 114 to the third inside bending section 113 side.

According to the structure of the main arm 10 of the comparative example, the rigidity of the main arm 10 in the longitudinal direction becomes weak as it gets closer to the supporting circular hole 11a which corresponds to the spindle 27 as the rotation center of the main arm 10 comparing with the structure of the main arm 10 of the above embodiment. Thus, the main arm 10 is likely to bend so that the improvement effect of the rigidity of the main arm 10 will be not sufficiently obtained. Thus, the arrangement position of the outside bending sections 121 to 124 and the arrangement position of the inside bending sections 111 to 114 of the main arm 10 in the comparative example are unsuited to provide for the structure having both the stress dispersion function and the rigidity improvement function.

### (Functions and Advantageous of the Embodiment)

By adopting the window regulator 1 of the embodiment as configured above, the following functions and advantageous effects can be obtained.

(1) Since one pair of the inside bending sections is arranged between one pair of the outside bending sections in the main arm 10, the height of the outside bead portion 12 from the inside extending portion 11 is made to increase gradually as it gets closer to the supporting circular hole 11a which corresponds to the spindle 27 as the rotation center of the main arm 10. As a result, the rigidity of the main arm 10 in the longitudinal direction can be strengthened. In addition, stress in lifting and lowering the window glass 2 by the driving force of the electric motor 21 can be dispersed and the amount of deformation of the main arm 10 which originates from the bending section can be reduced.
(2) The strength and rigidity can be improved since the origin of deformation of the main arm 10 can be reduced.
(3) The weight of the main arm 10 can be reduced by decreasing the thickness of the long steel plate since the strength and rigidity of the main arm 10 can be secured by the structure of the main arm 10.
(4) The manufacturing cost can be reduced since the main arm 10 can be reduced in thickness and weight.

Although the above embodiment explains the main arm 10 in the X-arm type window regulator 1, it is not limited thereto, for example, the above embodiment can be applied to the main arm in the single-arm type window regulator. Even the single-arm type window regulator can obtain effectively a structure having the stress dispersion function and the rigidity improvement function as with the window regulator 1 according to the above embodiment.

Also, although the above embodiment exemplifies the main arm 10 that the stress dispersion structures is provided at two positions in which the arrangement position of one pair of the adjacent outside and inside bending sections is defined so as to be reversed alternately toward the base end part side and the tip end part side of the main arm, the number of the stress dispersion structures arranged are not limited thereto. The stress dispersion structure may be disposed at a single position or not less than three positions. If the stress dispersion structure is disposed only at a single position, it is preferably disposed by the supporting circular hole 11a which supports rotatably the main arm 10.

Also, although the above embodiment exemplifies the case that the main arm 10 is applied to the power window regulator driven by the driving force of the electric motor 21, it is not limited thereto. For example, the main arm 10 of the above embodiment may be applied to a manual-type window regulator driven by the manual operation of the driver.

Also, although the above embodiment exemplifies the case that the main arm 10 has the stress dispersion and rigidity improvement structure, the stress dispersion and rigidity improvement structure described above may be applied to the sub-arm 3 as well. Thereby, the rigidity for the window regulator can be further improved.

As is clear from the above description, although the representative embodiments and the illustrative example of the invention have been described, the claimed invention is not limited to the above embodiments and the illustrative example. Modifications can be suitably implemented without departing from the gist of the invention. Further, it should be noted that all combinations of the features described in the embodiments are not necessary to solve the problem of the invention.

### INDUSTRIAL APPLICABILITY

This invention can be applied to a window regulator which is arranged in a vehicle door to lift and lower a window glass.

### REFERENCE SIGNS LIST

1 WINDOW REGULATOR
2 WINDOW GLASS
3 SUB-ARM
4 SLIDER
10 MAIN ARM
11 INSIDE EXTENDING PORTION
12 OUTSIDE BEAD PORTION
20 DRIVING UNIT
111, 112 FIRST AND SECOND INSIDE BENDING SECTIONS
121, 122 FIRST AND SECOND OUTSIDE BENDING SECTIONS

1. A window regulator for opening and closing a window glass arranged at a door of a vehicle, comprising an arm member that is rotated by a driving unit generating a drive force to lift and lower the window glass so as to lift and lower the window glass,
wherein the arm member comprises an inside extending portion that extends in form of a staircase via first and second inside bending sections that form folds comprising a mountain fold and a valley fold in a longitudinal direction, and an outside bead portion that is bent and projected outwardly from an outer peripheral end of the inside extending portion and that is bent in form of a staircase via first and second outside bending sections that form folds comprising a mountain fold and a valley fold in the longitudinal direction, and
wherein the first and second inside bending sections are formed between the first outside bending section and the second outside bending section.

2. The window regulator according to claim 1, wherein an arrangement position of the first outside bending section and the first inside bending section and an arrangement position of the second outside bending section and the second inside bending section are defined so as to be reversed alternately in the longitudinal direction of the arm member.

3. The window regulator according to claim 1, wherein the first outside bending section is formed at an one end part side of the arm member and the second outside bending section is formed at another end part side of the arm member, and
wherein a height of the outside bead portion from the inside extending portion is made to increase gradually from the second outside bending section to the first outside bending section side.

4. The window regulator according to claim 1, wherein the arm member is a main arm whose one end part in a longitudinal direction is connected rotatably to the driving unit, and whose other end part is connected movably to the window glass, and
wherein the arm member comprises a sub-arm which intersects with the main arm and is connected rotatably to the main arm, and whose one end part in a longitudinal direction is movably connected to an inside of the door and whose other end part is movably connected to the window glass.

5. An arm member, comprising:
an inside extending portion that extends in form of a staircase via first and second inside bending sections that form folds comprising a mountain fold and a valley fold in a longitudinal direction; and
an outside bead portion that is bent and projected outwardly from an outer peripheral end of the inside extending portion and that is bent in form of a staircase via first and second outside bending sections that form folds comprising a mountain fold and a valley fold in the longitudinal direction,
wherein the first and second inside bending sections are formed between the first outside bending section and the second outside bending section.

6. The arm member according to claim 5, wherein an arrangement position of the first outside bending section and the first inside bending section and an arrangement position of the second outside bending section and the second inside bending section are defined so as to be reversed alternately in the longitudinal direction of the arm member.

7. The arm member according to claim 5, wherein the first outside bending section is formed at an one end part side of the arm member and the second outside bending section is formed at another end part side of the arm member, and
wherein a height of the outside bead portion from the inside extending portion is made to increase gradually from the second outside bending section to the first outside bending section side.
